(19) United States
(12) Patent Application Publication
(10) Pub. No.: US 2003/0202124 A1
(43) Pub. Date: Oct. 30, 2003

(54) Ingrained field video advertising process

(76) Inventor: Ray M. Alden, Lake Brandon Trail, NC (US)

Correspondence Address: Ray M. Alden, 808 Lake Brandon Trail, Raleigh, NC, 27610, US

(21) Appl. No.: 10/133,657

(22) Filed: Apr. 26, 2002

(51) Int. Cl. H04N 5/222

(52) U.S. Cl. 348/722; 348/592

(57) ABSTRACT

The invention is a process which enables presentation of a first content at an event on a display means while concurrently dubbing a second content into a video airing of said display means. Thus onsite observers at the event see said first content on the said display means while concurrent observers of the event on television see the said second content which appears to be part of the actual onsite scenery. Steps in the process included first; providing a means for identifying a real world area to be defined as an engrained field, then creating the ingrained field within a first video stream, providing a second video stream (or image), and of injecting said second video stream or image into the ingrained field of the first video stream and thereby producing a third video stream. These steps can be done automatically and nearly concurrently in real-time for live broadcasting of sporting events for example. In a preferred embodiment, the invention can be used to provide segmented advertisements that appear to be at live events.

### BACKGROUND—FIELD OF INVENTION

This invention relates to presenting visual content to first hand observers while concurrently using video recording, electronic video processing, and multiple bit stream integration to incorporate secondary (video) content for television viewers. The invention is a process of first; identifying an area in real world space to be defined as an ingrained field, (said area providing content to on site observers), then creating the ingrained field within a video stream during the video recording process, and thirdly, of injecting a second video stream or image into the ingrained field to form a third video stream containing elements of the first two streams and then of presenting said third video stream to a television (or internet) audience. These steps can be done automatically and nearly concurrently for live broadcasting of sporting events for example. Specifically, during the recording process, areas to be treated as engrained fields are identified by specific predefined patterns and/or frequencies of electromagnetic radiation (preferably in the non-visible spectrum) and recorded in the video stream. A second video stream such as an advertisement is then injected into the embedded field during a nearly concurrent dubbing process. In an advertising embodiment, the result is that a first real advertising content is viewed by local live audiences and a second video advertising content is viewed by non-local television audiences concurrently in the “same space” that the real content would have appeared. In practice, in a segmented or regionalized advertising embodiment, the first (real) advertising content is televised to local audiences while a multitude of second regional specific video streams are concurrently injected into the said ingrained field and distributed such that multiple regional television audiences can each concurrently view different advertising within the same virtual (embedded field) advertising space. Said embedded field advertising content appearing to be part of the scene at the live event.

### BACKGROUND—DESCRIPTION OF PRIOR ART

Much regional advertising segmentation occurs during national television broadcasts. During a NASCAR automobile race for example periodic commercials are run which interrupt the racing action. Many of the commercials are local advertising content that only viewers in regional markets view. Both cable television and local broadcast television affiliates inject local ads into a percentage of the advertising time slots that are made available during the national broadcast for this purpose. In fact cable television is able to segment their advertising content to just small sections of a regional market. This enables very small businesses with a limited geographic appeal to accurately target only customers within close proximity to their business and thereby maximize the advertising dollar. All of this advertising is basically time sequenced advertising wherein the broadcast is interrupted for commercials breaks. Heretofore, no method other than time sequenced commercial slots has been provided whereby small regional business can target their small local market by advertising at a large national event itself (such as buying billboard space at a NASCAR race). The present invention provides a means for even small businesses to buy advertising space at national events.

Much advertising is done at the NASCAR track itself also. Specifically, bill boards are around the track, jumbo display screens are around the track, each car has sponsors ads on it, and each driver is wearing sponsor's ads. Yet none of these advertising venues has heretofore had the means to be geographically segmented as provided for herein. The method provided herein enables each of these venues to provide multiple advertisements concurrently each viewed advertisements each respectively viewed by different market segments.

The prior art is crowded with configurations of software and hardware (dubbing) that enable automated merging of two video streams such that the selected portions of each video stream are imposed upon one or another resulting in a single seamless video stream which integrates aspects of both streams. No prior art provides for a means of predetermining the locations in real world space that will be treated as virtual advertising space when recorded so as to be dubbed over concurrently with external content as provided herein specifically wherein the real world space provides local content (instead of a blank screen).

Prior art live automatically dubbed broadcasts includes the classic example of weather broadcasting. During the weather broadcast, the meteorologist is commonly video-recorded in front of a mono-chromatic background (such as a green wall, note that the monochromatic background presents no meaningful content to onsite observers of this process). A dubbing computer then removes all of the green wall from the video stream and replaces it with an image of a geographic map including weather events. The result of this process, as observed by the viewer, is a video image which appears to include the meteorologist standing in front of a weather map. Standard desktop PC software programs (such as Adobe Premiere for example) are now available to average consumers to achieve these types of video merges. While this practice of using a specified frequency of electromagnetic radiation (such as a specific shade of green) to queue a computer about which areas to cut from a video sequence has obvious value, it also has shortcomings. As discussed herein, this practice is not conducive to advertising local content at sporting events on a billboard or display means while concurrently advertising other content which appears to be at the event for reaching television viewers of the event whom are located in non-local geographical regions. The invention described herein provides a means to advertise one message (content) on a billboard (or display medium) to fans at the event while fans watching the same event on television observe a completely different advertising content appearing to be engrained into the same billboard (or display medium) whenever it is shown by the camera recording the event.

A second well known variety of real-time video stream merging is that of superimposing one video stream on top of another. Emergency “crawlers” for example are used to present video information on the bottom of a video stream without fully interrupting the video stream which was already in progress. This process was used extensively during the recent terrorist attacks upon the United States of America to keep viewers of regularly schedule content apprised of ongoing developments. While this process offers the advantage of presenting two video streams concurrently, it can not be used to enable local onsite observers of an event to view one advertising content on a billboard or advertising display means while concurrent television viewers of the event perceive the two video streams as though they are elements occurring at the live event.

A third example of prior art merging two video streams is illustrated by manual dubbing processes. Manually dubbing generally can not occur fast enough to accommodate the live event advertising process described herein

### SUMMARY

The preferred embodiment of the invention described herein relates to video recording, electronic video processing, and multiple bit stream integration. The invention is a process of first; identifying a real world area to be defined as an engrained field when recorded, then creating the ingrained field within a video stream, and thirdly, of injecting a second video stream or image into the ingrained field. These steps can be done automatically and nearly concurrently for live broadcasting of sporting events for example. Specifically, during the recording process, areas to be treated as engrained fields are identified by specific predefined patterns and/or frequencies of electromagnetic radiation (preferably in the non-visible spectrum) and recorded in the video stream. A second video stream is then injected into the embedded field such that a first real advertising content is viewed by local live audiences and a second video advertising content is viewed by non-local television audiences concurrently in the “same space” that the actual content would have appeared. In practice, in a segmented or regionalized advertising embodiment, the first (actual) advertising content is televised to local audiences while a multitude of second regional specific video streams are concurrently injected into the said ingrained field such that multiple regional television audiences can each concurrently view different advertising within the same virtual (embedded field) advertising space. Said embedded field advertising content appearing to be part of the scene at the live event.

Objects and Advantages

Accordingly, several objects and advantages of the present invention are apparent. It is an object of the present invention to provide a means to advertise content directed to targeted market segments. It is an object of the present invention to provide a means to change advertising content within recorded events. It is an object of the present invention to provide local content in an advertising space to onsite observers of an event while concurrently providing different content using the “same” advertising space when it is shown in a televised version of the event. It is an object of the present invention to provide a real-time means to provide targeted messages to multiple market segments. It is an object of the present invention to provide a means for identifying when a camera is recording an area which will be used to defme where an embedded field will appear within a video sequence. It is an object of the present invention that said means is not visible as such to local onsite observers.

Further objects and advantages will become apparent from a consideration of the drawings and ensuing description.

### BRIEF DESCRIPTION OF THE DRAWINGS

The following description of the invention and the related drawings portray a means of identifying a portion of real world space as being an area that when recorded is designated as being an automatically dubbed field or engrained field. A means of recording video and of engraining within the video automatically dub-able areas or engrained fields is provided. A second video stream or image is provided. Said second video stream or image being automatically dubbed into the dub-able area or engrained field within said first video stream. It will be understood, that the concept of the invention may be employed in any recording setting and presented to viewers through many mediums

The description of the invention relates to and is best understood with relation to the accompanying drawings, in which:

FIG. 1 Prior Art, illustrates a very common real-time dubbing process where a specific color is dubbed over.

FIG. 2, Prior Art, illustrates a commonly used process of dubbing local content over an ongoing broadcast.

FIG. 3 illustrates the process of the present invention of providing a local content and of dubbing over a predefined portion of the local content to provide new content.

FIG. 4a describes a first means of predefining a real world area as being an area over which different content is to be automatically dubbed.

FIG. 4b describes a second means of predefining a real world area as being an area over which different content is to be automatically dubbed.

FIG. 4c describes a means of predefining multiple real world areas over which different content is to be automatically dubbed.

FIG. 5a illustrates a first camera architecture for recording presence of a predefined auto-dub field.

FIG. 5b illustrates a second camera architecture for recording presence of a predefined auto-dub field.

FIG. 6 illustrates a flowchart for designating a real world space as a virtual advertising space, camera sensing of the scene inclusive of designated space, camera producing a video stream with designated space coded green, dubbing CPU editing new content into the video stream to produce a new video stream with engrained advertising therein.

FIG. 7 illustrates the national architecture process of predefining a real world area as an auto-dub field, recording said field as part of event, and automatically dubbing in new content within the predefined field.

FIG. 8 illustrates the local architecture process of predefining a real world area as an auto-dub field, recording said field as part of event, and automatically dubbing in new content within the predefined field.

FIG. 9 illustrates a monochromatic field approach (with no local content) of predefining an auto-dub field.

FIG. 10 illustrates a non-visible field approach (with local content) of predefining an auto-dub field.

FIG. 11 illustrates an alternate embodiment for predefining a real world area as an auto-dub field, that of GPS co-ordinance and logic.

### DESCRIPTION AND OPERATION OF THE FIRST PREFERRED EMBODIMENTS

In a first embodiment, non-visible electromagnetic radiation is used to define when a camera has within its view an area which is to be embedded within the video.

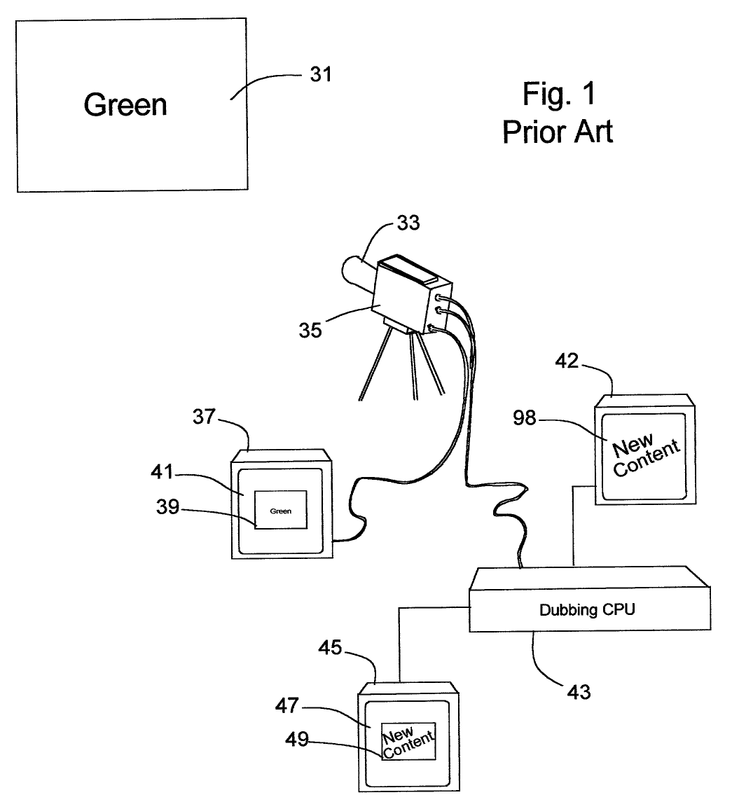

FIG. 1 Prior Art, illustrates a very common real-time dubbing process where a specific color is dubbed over. A green screen 31 is shown as part of a scene which is recorded by a standard video camera 35. Said 35 having a standard video lens 33. A live camera display 37 displays the scene 41 including the green field 39. A new content 98 is provided as displayed on new content display 42. A dubbing CPU 43 has been programmed to look for and dub over specific color patterns (such as a green field), it senses the presence of the 39 coming from the camera and automatically inserts the 98 into the stream from 35 to produce a new scene 47 including new content dubbed into the green field 49 (both of which are displayed on resultant monitor 45). This process is well known and has historically been widely used in weather broadcasting for example. In weather broadcasting, the meteorologist stands in front of a green field when doing the forecast, the green field is dubbed out and a weather map is dubbed in such that the viewer perceives that the forecast has been done in front of a weather map. Even consumer grade video editing software such as Adobe Premiere has the capability to perform this type of editing. This process has not heretofore been used for inserting advertisements into live video streams. Particularly, this process has not heretofore been used to insert secondary content over original meaningful content (instead of a blank green screen) as described herein.

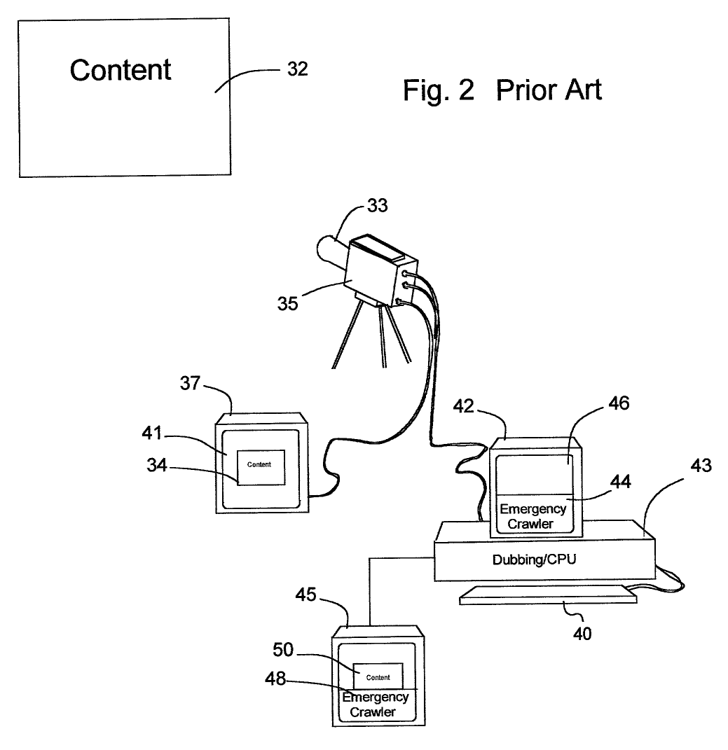

FIG. 2, Prior Art, illustrates a commonly used process of dubbing local content over an ongoing broadcast. A local content 32 is being recorded as part of the scene by 35. The 37 displays the camera's output as 41 this time including content on display 34. 42 displays an emergency crawler 44. The 43 has been given instructions to run the 44 over the 41 and therefore produces the resultant video as displayed on 45. A dubbed in emergency crawler 48 is obviously not part of the programming content such as encroached content 50 but is instead a separate information stream whereby two information streams are running on 45 concurrently. This well known and widely used process is valuable for displaying two concurrent information streams. It is however, not well suited to engraining advertising into events such that viewers perceive the advertising to be occurring at the actual event as is described by the present invention.

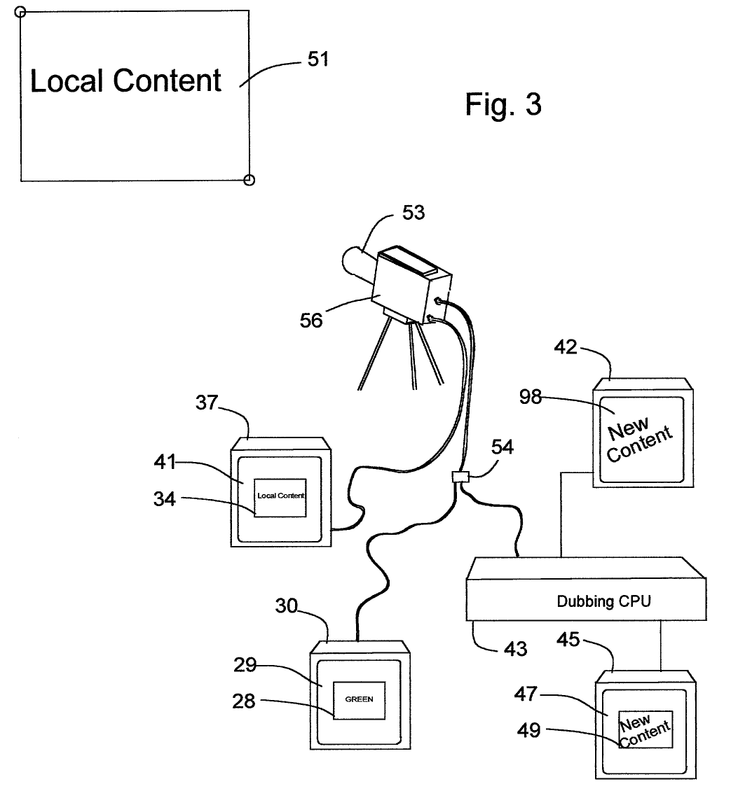

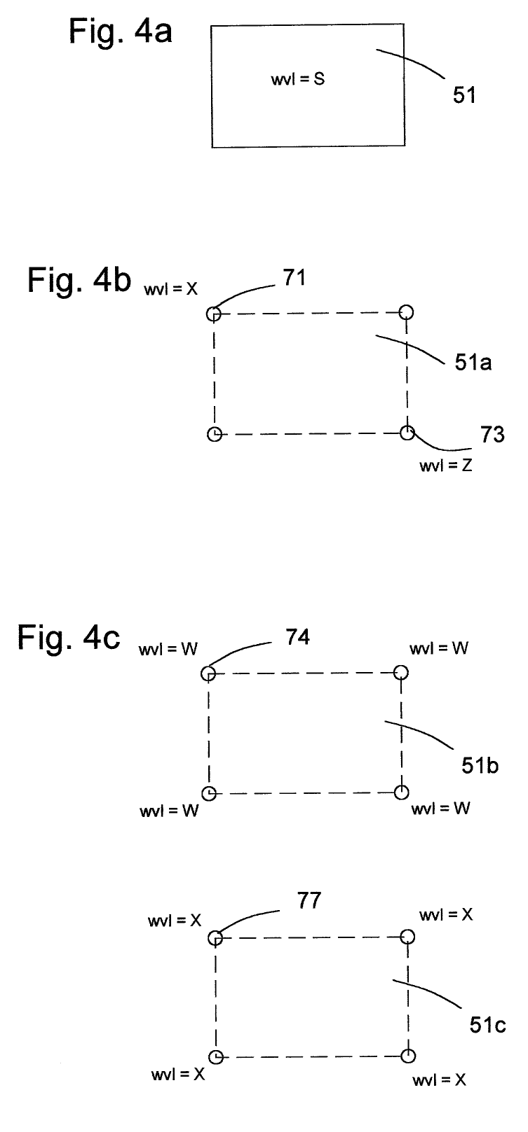

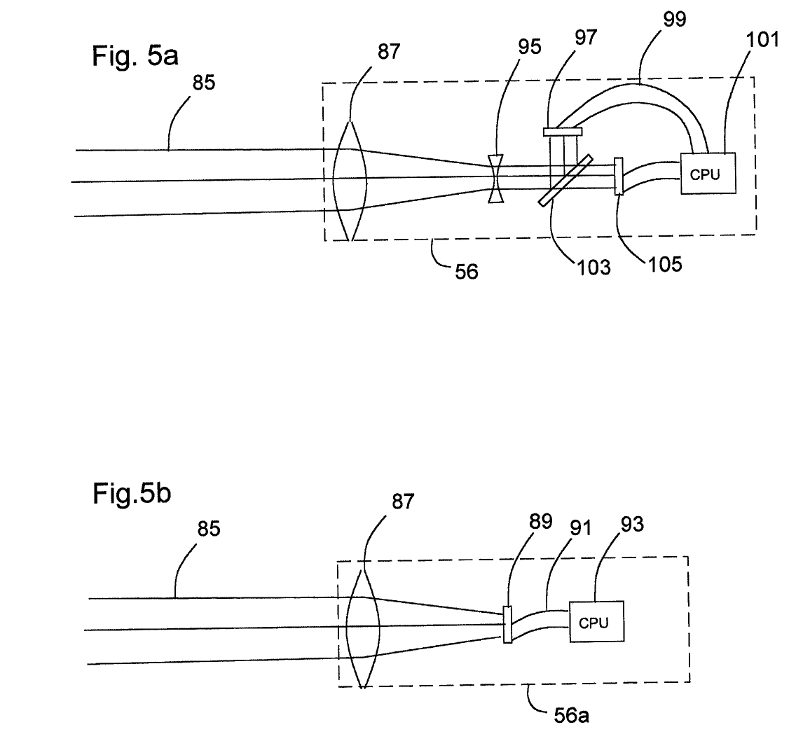

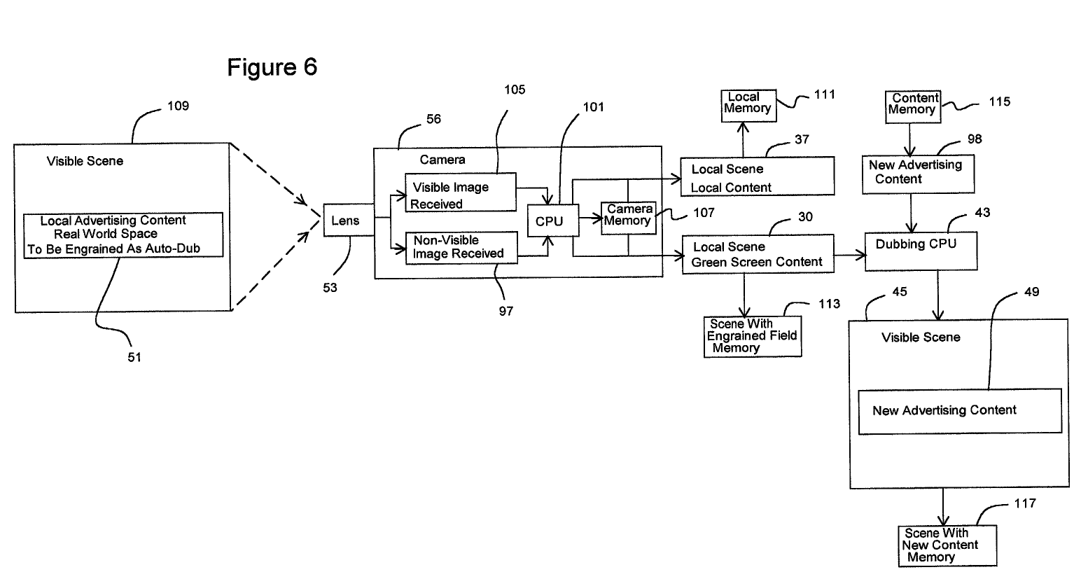

FIG. 3 illustrates the process of the present invention of providing a local content and of dubbing over a predefined portion of the local content to provide new content. A local content area 51 has been defined (as later discussed) as a space over which to create a virtual advertising space. Every time the camera records the space as it pans to and fro, the space will continue to be recorded as an engrained virtual advertising space. A modified lens 53 on a modified camera 56 produces two output streams. A first out put stream as appearing on 37 resembles the actual scene. In the second video stream, as illustrated on second stream display 30, the camera has designated the area 51 as a green scene and output a green field 28 in place of the local content 51 as part of the dubbed scene 29. The 53 and 56 are further describe in FIG. 5a. A signal splitter 54 also carries the second stream to 43. The 43 has instructions to automatically dub 98 into the green screen it detects from 56. The result as displayed on 45 is the new content dubbed over the local content just as was the case in FIG. 1. The difference is that 51 is local content instead of a green screen. Area 51 was defined by the means described in FIG. 4 and sensed by the 56 according to FIG. 5a which internally converted it to a green field according to FIG. 6. Thus local content is replaced by new content.

FIG. 4a describes a first means of predefining a real world area as being an area over which different content is to be automatically dubbed. In this case, the entire space of 51 is emitting an invisible frequency of electromagnetic energy with wavelength=S. The 56 of FIG. 3 has been programmed to detect this invisible wavelength and to designate the area containing the wavelength as a green field in its second video stream. Thus the camera produces a first video stream with no engrained field and a second video stream with a green engrained field which will be detect by the dubbing CPU. Infrared LEDs in array can cover the surface of 51 and be caused to emit invisible electromagnetic radiation which is detected by the 56. Many other means for producing specific frequencies of invisible wavelengths of electromagnetic radiation are well known

FIG. 4b describes a second means of predefining a real world area as being an area over which different content is to be automatically dubbed. An X wavelength emitter 71 defines a first corner of an area which is a real world space 51a which is to be designated as a virtual advertising space. A Z wavelength emitter 73 defines a second corner of a rectangular advertising space. The 56 of FIG. 3 has been programmed to detect these two wavelengths of invisible electromagnetic radiation and to construct a rectangle using X as the upper left corner and Y as the lower right corner. The camera then colors the box in green, thus creating the automatic dub zone for the dubbing CPU. X and Z wavelengths are emitted by infrared LEDs being pulsed synchronously so as to designate the real world space an area to be a virtual advertising space.

FIG. 4c describes a means of predefining multiple real world areas over which different content is to be automatically dubbed. The 56 of FIG. 3 has bee programmed to look for a range of invisible wavelengths to be defined as fields for auto dubbing. A W wavelength emitter is one of four such emitting LEDS that emit invisible electromagnetic radiation. 56 detects these emitters and connects their individual locations in virtual space to from a rectangle and fills the rectangle in with a first green color. Concurrently, an X emitter 77 is one of 4 X emitters describing the perimeter of a real world space which is to be engrained into the video signal as an automatically dub-able field. The camera detects the X emitters and constructs a rectangle connecting them. The camera fills the rectangle with a second shade of green. The 43 has been programmed to detect the second shade of green field and to insert a second advertising content into that field. Thus multiple virtual advertising spaces can be captured at one event wherein each space will receive distinct new content which appears to be emanating from the actual live event.

FIG. 5a illustrates a first camera architecture for recording the presence of a predefined real world space to be recorded as an auto-dub field. Incoming electromagnetic radiation 85 is focused by a focusing optic 87. The 87 being suitable for focusing visible light as well as non-visible electromagnetic energy used to designate fields as described in FIG. 4c. A collimating optic 95 collimates the 85. A light splitter sends visible light to a visible spectrum CCD 103 to be sensed. The non-visible light of wavelengths described in FIG. 4c, are reflected by the 103 to be sensed by an infrared CCD 97. (Alternately a CMOS or photo diode array can be used to sense infrared.) The sensed signals from 105 and 99 are processed by a modified camera CPU 101. The camera CPU processes the image produced by the 103 just as does a normal camera and sends out the first video stream as seen on 37 in FIG. 3. The camera CPU process the 97 image to determine whether imbedded fields are present. If an embedded field is sensed, the CPU codes the field one of a set of designated colors (such as a shade of green) and sends this video stream to the 43 for automatic dubbing. Producing the stream as seen on 45.

FIG. 5b illustrates a second camera architecture for recording presence of a predefined auto-dub field. A wide spectrum CCD 89 detects light in the visible range as well as light outside of the visible range which is describe in FIG. 4c. The second camera CPU 93 checks the video stream from the 89 and creates green fields as discussed in FIG. 5a. It too produces two video streams as displayed on 37 and 30 of FIG. 3.

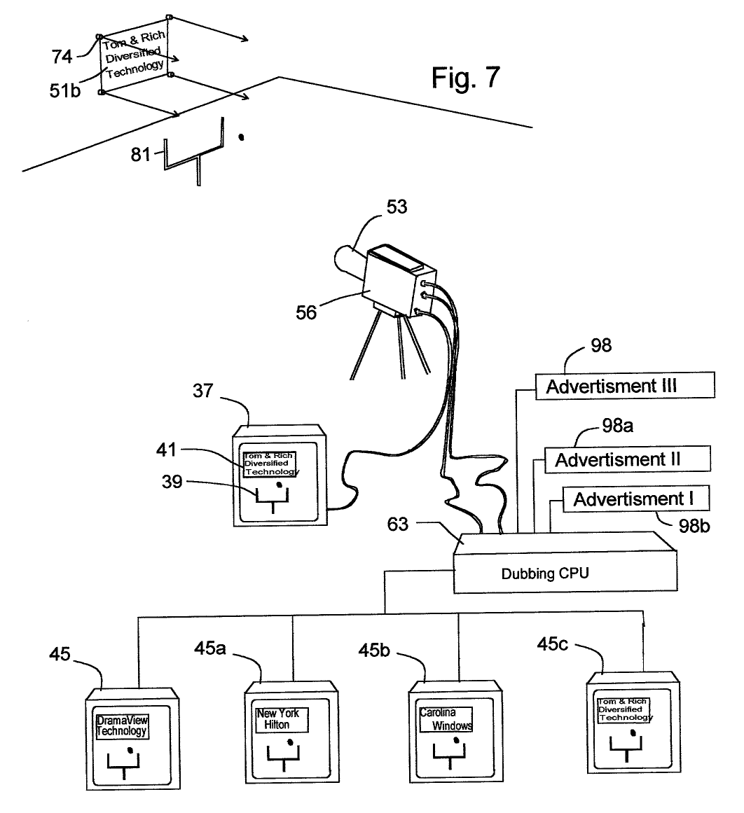

FIG. 6 illustrates a flowchart for designating a real world space as a virtual advertising space, camera sensing of the scene inclusive of designated space, camera producing a video stream with designated space coded green, dubbing CPU editing new content into the video stream to produce a new video stream with engrained advertising therein. A 109 visible scene includes 51 which is designated as a field to be virtual advertising space by emission of non-visible electromagnetic radiation (according to FIG. 4). The 53 and the 56 collect information about the image and any non-visible signals within predetermined wavelengths. A visible image receiving means 105 such as a CCD is provided and a non-visible image receiving means 97 such as an infrared CCD are provided. The 101 CPU processes the image information from 97 and 105. An image of the scene is produced as with a normal camera and output at 37. A local memory 111 may be provided to record the 37 output. The 101 also processes the signals from 97 and 105 to determine whether any virtual fields are to be created. It searches for specified frequencies of electromagnetic radiation occurring in specified patterns. When a specified frequency and pattern is encountered, the camera defines the space virtually in a video stream and fills the field with one of a predetermined color selections. The camera then outputs the video stream with engrained virtual field as displayed at 30. Scene with engrained field memory 113 can be provided to store the video steam with engrained green fields. The 43 then receives the video with engrained green fields into which it automatically dubs new advertising content 98 which has been stored in a content memory 115. The 43 outputs a video stream as seen on 45 with the new advertisement 49 within the video stream A scene with new content memory 117 can be provided to store this stream FIG. 7 illustrates the national architecture process of predefining a real world area as an auto-dub field, recording said field as part of event, and automatically dubbing in new content within the field. A billboard advertisement 51b at a Super bowl football game is surrounded by emitters of non-visible electromagnetic energy such as 74. As the camera focuses on the football going through goal posts 81, the 51b ad is recorded behind the 81. Also recorded, is the presence of the 74 and other emitters. The camera produces a first video out as displayed on 37. The camera sends the second video stream designating 51b as a green field to a multi-stream dubbing CPU 63. A first advertising content 98, a second advertising content 98a, and a third advertising content 98b are each accessed by the 63 and dubbed into separate streams which are sent to different regions of the country. The 45 receives a first stream with 98, a second out monitor 45a receives a second stream with 98a, and a third output monitor 45b receives a third stream with 98b. Note that 45c displays the original advertising content as seen on 37 which has come directly from the camera output. Thus, the designated space was sensed, a virtual advertising space was engrained into the video stream and multiple advertisements were inserted into the virtual space to produce video streams for distribution to various regions of the country. Meanwhile viewers in each respective region of the country perceive that the advertisement they saw was actually present at the live event.

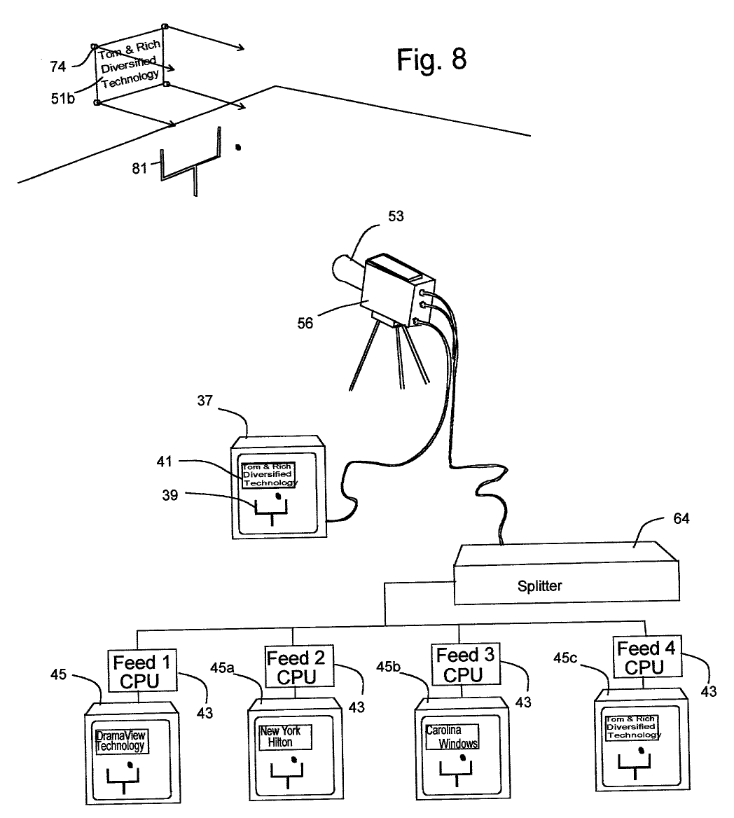

FIG. 8 illustrates the local architecture process of predefining a real world area as an auto-dub field, recording said field as part of event, and automatically dubbing in new content within the predefined field. This embodiment differs from FIG. 7 only in that the national broadcast company broadcasts to its network affiliates the signal with areas designated to receive advertising and the local affiliate actually dub in the advertisements themselves. Each affiliate having a separate commercial stream to inject with their own respective 43. The final output is the same as FIG. 7.

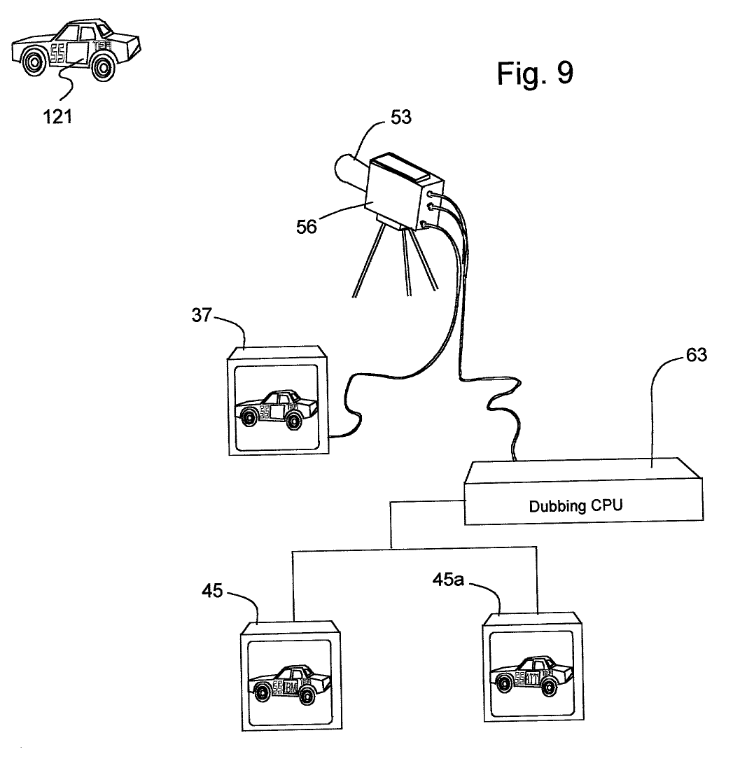

FIG. 9 illustrates a monochromatic field approach (with no local content) of predefining an auto-dub field. The stock car has a blank field 121 that is detected by the 56. Each time the 121 appears in the scene (as the car goes around the track), the 63 dubs a first IBM ad in for one region of the country as seen on 45 and a second AT&T ad in for a second part of the country as seen on 45a.

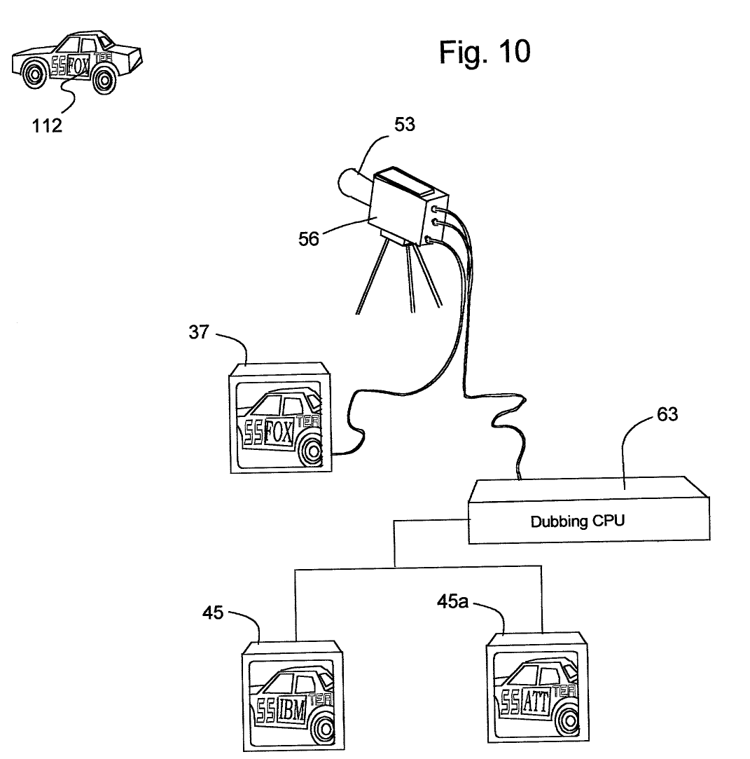

FIG. 10 illustrates a non-visible field approach (with local content) of predefining an auto-dub field as described in FIG. 4. A stock car advertisement 112 is designated as a real world space by emitters of non-visible electromagnetic radiation as previously discussed (not shown). The 63 inserts ads into the virtual space which is created as previously discussed such that two advertisements are sent to different market segments as previously discussed. One market segment will see IBM as a sponsor of the stock car while another market segment sees AT&T as a sponsor of the stock car. Meanwhile viewers on site at the event, see FOX as a sponsor of the stock car. It should be noted, that in a subsequent re-airing of the event, the sponsor adds that are inserted into the spaces may be changed as desired. So later viewers of the recorded event may see altogether different advertisers of the stock car.

Description and Operation of the Second Preferred Embodiments

In a second embodiment, a system of three-dimensional coordinates is used to define when a camera has within its view an area which is to be embedded within the video.

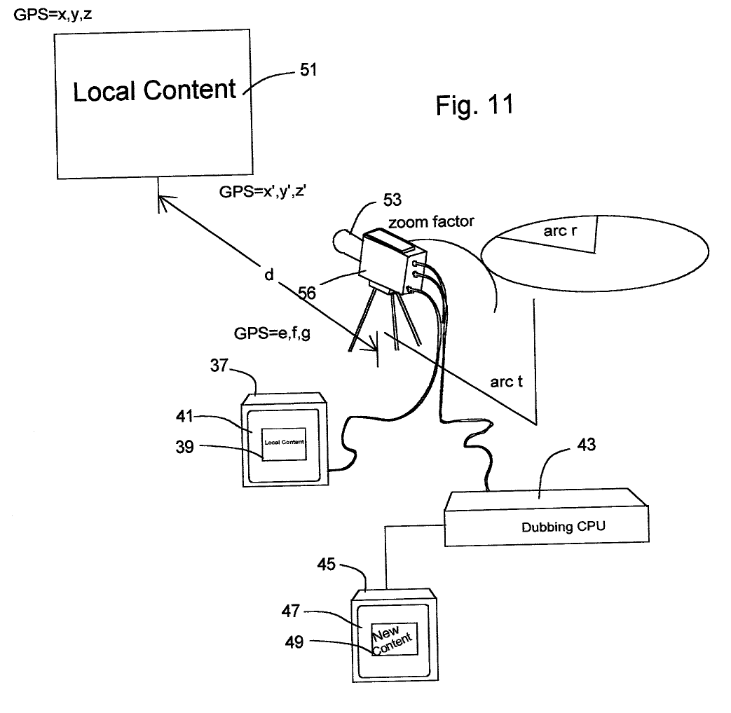

FIG. 11 illustrates an alternate embodiment for predefining a real world area as an auto-dub field, that of GPS co-ordinance and logic. A camera is equipped with sensors and logic such that the GPS co-ordinance of its field of view are known. Also stored in its memory are the presence of real world spaces which are to be treated as virtual advertising spaces. Calculations are made to determine that 51 is such a space. The process described in FIG. 6 is then used to create the embedded field for dubbing.

Additional Embodiments.

The present process is described herein in terms of television presentation but it will be obvious to one skilled in the art that the process can also be used with broadcast, satellite, cable, internet or any other means of transferring signals and presenting video images.

The examples provide herein are primarily drawn to the advantages of presenting concurrent live image streams. It should be easily recognized that once the fields are engrained within the video signal, the video can be replayed with totally new advertising content injected into the fields each time it is rebroadcast or rerecorded. Each of these engrained video streams would appear to the viewer to have been recorded with the original recording at the live event.

The description herein primarily focused on advantages at live events. It should be noted that the process described herein can also be used for recording movies or other content which feature products within embedded fields being used by actors. Each time the movie is rebroadcast, different brand name products can be injected into the fields to maximize revenue for the owners, or broadcasters of the video content.

The description provided herein describes in detail the use of the present invention to regionally segment advertising content for users. It will be understood that the same process can be used to segment audiences according to many other factors. For example, when providing video over the internet, the advertising engrained into the video can be selected according to personal preferences preset on the user's computer. Alternately, personal preferences could be set on the viewer's cable box settings.

The process described herein includes a camera means to record the presence of a predetermined engrained field and a camera means to convert the engrained field to a green screen type of monochromatic field. It should be noted that the field need not be converted to a green field in the camera. In another embodiment, the camera records the presence of the virtual advertising field but does not fill the field with color. In this embodiment, the dubbing CPU that receives the signal from the camera can detect the presence of the engrained field and auto-dub into the field with no green screen field conversion required.

Many other steps or combination of steps with hardware and/or software are possible to perform essentially the same process described herein.

In another embodiment, when recording the scene, a camera can be used to capture the scene and a separate sensor can be used to capture the presence of the real world space to be designated as a virtual advertising space.

Emitters of non-visible electromagnetic radiation are described herein to define the boundaries of a virtual advertising space but other methods are possible. Fore example, the real world space can be defined by reflective means wherein certain wavelengths of electromagnetic energy are reflected from the designated space. Other means are also possible.

The camera can output the video stream including marked areas where the embedded field is without coloring these fields greens as described herein. In this case, a dubbing CPU can insert new content into the said fields in some markets while broadcasting the video without inserted fields in other markets. Alternately, during live broadcast, the dubbing CPU can include or exclude the inserted ads while in playback broadcasts the dubbing CPU can do the opposite if desired.

The preceding is not to be construed as any limitation on the claims and uses for the structures disclosed herein.

Advantages

Accordingly, several objects and advantages of the present invention are apparent. It an object of the present invention to provide a means to advertise content directed to targeted market segments. It is an object of the present invention to provide a means to change advertising content within recorded events. It is an object of the present invention to provide local content in an advertising space to onsite observers of an event while concurrently providing different content using the “same” advertising space when it is shown in a televised version of the event. It is an object of the present invention to provide a real-time means to provide targeted messages to multiple market segments. It is an object of the present invention to provide a means for identifying when a camera is recording an area which will be used to define where an embedded field will appear within a video sequence. It is an object of the present invention that said means is not visible as such to local onsite observers.

Further objects and advantages will become apparent from a consideration of the drawings and ensuing description.

Benefits of the Present Invention

The invention disclosed herein is a new process for presenting video content which to the viewer appears to be part of the actual real world space at the event but instead has been injected from a second video stream into the first video stream to appear to be part of the real world scene. One benefit of the present process is that live onsite observers of an event can see actual content in a real world space while concurrently, viewers of a video recording (or live airing) of the event see content which appears to have been recorded as part of the real world event but which is actually injected to present content that was not present at the real world event. A second benefit is that small advertisers can advertise at events using a real billboard space or other display media space at the event. Other advertisers can use the same real billboard or other display media areas within the video recording or live broadcast to advertise different content. This enables small advertisers to advertise “on” bill boards at the Superbowl for example while reaching only small market segments within their regional area. Later, during rebroadcast, a third advertiser can advertise their product using the same video space. Many benefits will accrue to advertisers, television networks, television broadcast companies, cable companies, and viewers of events. Heretofore, local content engrained into a live video stream was not easily dubbed-over and replaced concurrently in real-time. The present invention enables a small, regional business in Raleigh, N.C. to advertise on Dale Earnhart Jr.'s race car, or buy billboard space at the World Series.

Conclusion, Ramifications, and Scope

Thus the reader will see that the INGRAINED FIELD ADVERTISING PROCESS of this invention provides a highly functional and reliable means to present a first (local) visual content to onsite viewers of a billboard or display means located at an event while concurrently presenting a second visual content to television viewers of the same billboard or display means. The later viewers being unable to discern that the second video stream is not being recorded at the actual live site. The process can be done in real-time with an event or can be done during rebroadcast of the event. This process offers the advantage of maximizing advertising revenue through precise market segmentation and in advertising venues that were previously not available to most advertisers. Viewers at the event receive advertising which is relevant to their area while concurrently, using the same advertising space, viewers in a different geographic area receive advertising relevant to their area that appears to emanate from and is engrained into the live event. This makes it possible for a company with only a presence in a small geographic area to appear as an advertiser on a national level while not wasting any of the advertising on viewers outside of the company's market.

The process described herein includes a camera means to record the presence of a predetermined engrained field and a camera means to convert the engrained field to a green screen type of monochromatic field. It should be noted that the field need not be converted to a green field in the camera. In another embodiment, the camera records the presence of the virtual advertising field but does not fill the field with color. In this embodiment, the dubbing CPU that receives the signal from the camera can detect the presence of the engrained field and auto-dub into the field with no green screen field conversion required.

Many other steps or combination of steps with hardware and/or software are possible to perform essentially the same process described herein.

In another embodiment, when recording the scene, a camera can be used to capture the scene and a separate sensor can be used to capture the presence of the real world space to be designated as a virtual advertising space.

Emitters of non-visible electromagnetic radiation are described herein to define the boundaries of a virtual advertising space but other methods are possible. Fore example, the real world space can be defined by reflective means wherein certain wavelengths of electromagnetic energy are reflected from the designated space. Other means are also possible.

The camera can output the video stream including marked areas where the embedded field is without coloring these fields greens as described herein. In this case, a dubbing CPU can insert new content into the said fields in some markets while broadcasting the video without inserted fields in other markets. Alternately, during live broadcast, the dubbing CPU can include or exclude the inserted ads while in playback broadcasts the dubbing CPU can do the opposite if desired.

Accordingly, the scope of the invention should be determined not by the embodiment(s) illustrated, but by the appended claims and their legal equivalents.

What is claimed:

1. An advertising process wherein a real world space is designated as virtual advertising space, wherein a means is provided to determine that said designated real world space is to be coded as virtual advertising space, wherein a video capturing means is provided to produce a first video information stream of the scene containing said real world space, wherein an advertisement content is dubbed over the said virtual advertising space resulting in an advertisement ingrained within a resultant video stream.

2. The invention of claim 1 wherein said video capturing means determines the presence of said virtual advertising space.

3. The invention of claim 1 wherein a means is provided to determine the presence of said virtual advertising space.

4. The invention of claim 1 wherein a means is provided to determine the presence of said virtual advertising space through calculations.

5. The invention of claim 1 wherein characteristics of said real world space is defined by electromagnetic energy.

6. The invention of claim 5 wherein said electromagnetic energy is outside of the visible range.

7. The invention of claim 1 wherein said real world space is itself an advertisement.

8. A means of designating a real world space as a space which is to be automatically dubbed over, wherein a video capturing means which produces an information stream describing the scene containing said space is provided, and wherein the presence of said space is engrained within said information stream.

9. The invention of claim 8, wherein said information stream including said engrained space is stored.

10. The invention of claim 8, wherein n additional content is automatically dubbed over said engrained space.

11. A video dubbing process wherein; a means is provided to identify an area within a scene to be defined as a field over which to automatically dub additional content, wherein
said area within said scene includes a first content which is visible to onsite observers,
wherein a first video stream is collected including at least some of the said field,
said first video stream including a means to identify said area as a said field over which to automatically dub,
wherein a second content is provided,
and said second content is dubbed into the said field to produce a second video stream.

12. The invention of claim 11, wherein said first content is an advertisement.

13. The invention of claim 11, wherein said first content appears on a billboard.

14. The invention of claim 11, wherein said first content appears on a display screen.

15. The invention of claim 11, wherein said second content is an advertisement.

16. The invention of claim 11, wherein said means to identify is at least one frequency of electromagnetic radiation.

17. The invention of claim 16 wherein said frequency is not visible to the human eye.

18. The invention of claim 11, wherein said means to identify includes software to describe the position in three dimensional space of a means which senses electromagnetic radiation.

19. A method of defining a field within a scene that is to be dubbed over, wherein a means to emit invisible electromagnetic radiation defining said field is provided, and a means to sense said invisible electromagnetic radiation is provided.

20. A video camera for sensing automatically dub-able areas within a scene wherein said automatically dub-able areas are designated by invisible electromagnetic energy and wherein said camera senses said invisible electromagnetic radiation.
